(19) United States
(12) Patent Application Publication
(10) Pub. No.: US 2016/0167117 A1
(43) Pub. Date: Jun. 16, 2016

(54) SALT CORE AND ADDITIVE MANUFACTURING METHOD FOR PRODUCING SALT CORES

(71) Applicant: EMIL MÜLLER GMBH, Whihermsdorf (DE)

(72) Inventor: Thorsten HARTIG, Puschendorf (DE)

(21) Appl. No.: 14/906,816

(22) PCT Filed: Jul. 24, 2014
(86) PCT No.: PCT/EP2014/065933

§ 371 Date: Jan. 21, 2016

(30) Foreign Application Priority Data
Jul. 24, 2013 (DE) 102013214466.0

(51) Int. Cl. B22C 9/10; B22C 9/12; B22C 1/22

(52) U.S. Cl. CPC B22C 9/105; B22C 1/22; B22C 9/12; B33Y 10/00

(57) ABSTRACT

The invention relates to a salt core for producing cast parts, said salt core having a layered structure formed from layers of a moulded material which are applied individually and which are solidified. Said salt core is produced according to an additive manufacturing method, in particular, selective laser sintering.

The invention relates to salt cores as cavity placeholders in castings and/or plastic molded parts and additive manufacturing methods for producing such salt cores. In particular, the invention relates to salt cores that can be produced by means of selective laser sintering.

The preferred field of use for such salt cores is all casting methods for light metals and nonferrous heavy metals and production methods for plastics and/or carbon-fiber- and glass-fiber-reinforced components.

In the case of many products produced by casting, it is necessary to produce cavities in the interior or undercuts in the exterior region. In unpressurized methods, such as gravity casting, a core composed of consolidated sand or salt is positioned within the mold and overcast with metal melt, wherein the casting mold is filled and the core is surrounded with melt.

In the context of this invention, the term “casting” should comprise not only metal castings but rather in general all components that are cast, injection-molded, or otherwise produced with the help of cores. In particular, plastic molded parts, which are produced for example by means of injection molding, should also be comprised.

Dry-pressed salt cores have been in use in founding for decades. This known manufacturing method is used for products with simple geometries.

A further production method for salt cores is core shooting. By means of core shooting, salt cores having significantly more complex geometries can be reliably produced. Both methods, dry pressing and core shooting, have the disadvantage that a primary shaping tool is always required. The production of primary shaping tools is complex, time-intensive, and costly. Furthermore, primary shaping tools are subject to manufacturing wear.

In addition, the production of single-part molds and cores having undercut contours is not possible with respect to molding. The production of pressed cores having complex geometries is possible only by means of downstream process steps.

The problem addressed by the invention is that of avoiding the mentioned disadvantages, particularly that of providing salt cores having complex geometries and providing a method for producing such cores.

This problem is solved by means of salt cores according to claim 1 and by means of a method according to claim 8. Advantageous developments of the subject matter of the invention can be found in the dependent claims.

Accordingly, a salt core according to the invention for producing castings is characterized in that the salt core has a layered structure, wherein the layered structure consists of individually applied and consolidated layers of molding material.

According to an especially preferred embodiment of the invention, the salt cores are soluble, particularly water-soluble, so that the salt cores can be removed from a casting without residue.

A method according to the invention for producing a salt core is characterized in that the salt core is produced by means of an additive manufacturing method. Preferably, a molding material is consolidated by means of selective laser sintering.

A method according to the invention for producing salt cores differs from methods known from the prior art in that the salt cores can be produced without the use of primary shaping tools and that a salt covered with binder is selectively hardened by means of electromagnetic radiation.

The cores according to the invention are produced from a molding material, comprising at least one salt covered with binder and possibly comprising auxiliary materials such as filling materials, additives, wetting agents, and catalysts.

According to a preferred embodiment of the invention, the salt core can be designed hollow, wherein the interior of the salt core can be empty or filled with unconsolidated molding material.

Especially preferably, the salt core consists of a selectively laser-sintered surface shell, while the inner molding material portion surrounded by the consolidated surface shell is not laser-sintered.

The salt core produced by laser sintering can be coated with a water-soluble facing or infiltrated with a salt melt in order to close open pores close to the surface.

It was found that it is possible to insert and mount a multitude of functional parts, which serve to produce, for example, transmissions, drive elements, pumps, channels, and pipe systems, in a hollow molded body not only after the end of the production of said hollow body, but rather to insert these functional parts into a water-soluble salt core, which is then overcast with metal or plastic in a casting method. Thereafter, the water-soluble salt core is rinsed out and the functional parts are already present in the desired position and function in the hollow molded body.

Accordingly, such a salt core comprises at least one component, particularly selected from gears, transmission parts, shaft elements, or drive elements, in form-closed connection. The at least one component is largely surrounded by the salt core, i.e., completely or partially, so that no back-casting with melt and no flake formation occur when the overcasting is performed. In general, only the shafts or shaft bearings protrude from the salt core or lie at the surface of the salt core.

Especially preferred is the method of selective sintering of salt covered with binding agents by means of a laser. In this method, the advantages of core shooting and of dry pressing are combined with each other:
Because of the construction in layers, high complexity of the mold/of the core can be realized. Likewise, it is possible to generate hollow structures.
Economical and substantially biologically/ecologically harmless salts can be used for the selective laser sintering.
The particles are sintered by computer-controlled, selective heating of a thin salt layer by means of a laser. In the process, the binding agent is cured and “sinters” the individual salt particles to each other.
The selective sintering operation must be repeated for each newly applied molding material layer.
No warping arises at the component due to the construction in layers and the local sintering. Because only small regions are heated and sintered, volume contraction does not occur during the solidification.
The porosity/gas permeability of the produced cores/molds can be set in a specific manner.
The cores can be removed in a simple manner and without residue, because the cores can be composed exclusively of water-soluble components.
High flexibility and speed in the case of small series and prototypes
No tool costs

Crystalline salt, which is covered with or mixed with a warm- or hot-curing binder, is used as a molding material. During the selective sintering, the binder is cured by means of electromagnetic radiation so that the salt particles are “sintered” to each other. However, the sintering process should not be confused with a ceramic or metal sintering process, wherein the grains of the matrix material sinter. Here, a binding agent merely is cured, yet the term “sintering” is likewise used for this.

The crystalline salt can have a unimodal grain size distribution or a bi- or multimodal grain size distribution. A bi- or multimodal grain size distribution can be advantageous with regard to especially tight packing of the crystals. The porosity present in the salt cores according to the invention can thus be varied. After the selective laser sintering, the salt cores according to the invention have a residual porosity of less than 30%, preferably of less than 5%, and particularly preferably of less than 2% with respect to the total volume of the salt core.

According to a preferred embodiment of the invention, the grain sizes of the crystalline salt lie in a range of 0.01 mm to 2 mm, wherein the grain sizes of the crystalline salt particularly preferably lie in a range of 0.01 to 0.29 mm, 0.3 to 1.3 mm, and/or 1.31 to 2.0 mm. The first two fractions can be used as rather fine-grained salt and the last fraction can be used as rather coarse-grained salt in mixtures of multimodal composition.

Important selection criteria for the salts to be used are the toxicity thereof and the solubility, particularly in water.

Preferably chlorides, sulfates, phosphates, or nitrates of the alkali, alkaline-earth, or subgroup elements, or mixtures of said salts, particularly sodium chloride, potassium chloride, magnesium chloride, and/or potassium sulfate, magnesium sulfate, ammonium sulfate, sodium sulfate can be comprised or contained as salts.

A method according to the invention for producing such salt cores is distinguished in that the salt molds and salt cores are constructed in layers.

Furthermore, the method according to the invention is distinguished in that the molding material is a powdery, granular, or granulated salt or a mixture of salts having round, irregularly shaped or angular, splintery crystals. The salt is mixed with a binder and is especially preferably covered with this binder.

Preferably, the binder is a resin from the group of the phenolic resins, phenol-urea-formaldehyde resins, the nitrogen-free or low-nitrogen phenol-formaldehyde resins, the phenolic resins containing furfuryl alcohol, furfuryl alcohol-urea-formaldehyde resins, the furan resins, the phenol-modified furan resins, the amino resins, the novolacs, or the resols, which resin can be used in liquid or solid form.

The salt core produced by means of the additive manufacturing method can be post-hardened in a furnace. Depending on which binding agent is treated with which laser, it can be advantageous to subsequently perform a further hardening step in a furnace. In the further hardening step, more volatile constituents of the binder also can be driven out, in accordance with a further embodiment of the invention. This has the advantage that these constituents do not first escape during the use of the core, e.g., during the light-metal casting, and then lead to undesired blistering in the casting.

A method according to the invention for producing salt cores by means of selective laser sintering can comprise, for example, the following steps:
Producing a data model of a salt core to be produced
Preparing a molding material mixture of salt and binder
Applying a thin molding material layer to a lowerable supporting plate
Selectively hardening the molding material layer in regions corresponding to the data model by means of electromagnetic radiation, particularly by means of laser irradiation, in a computer-controlled manner
Lowering the supporting plate
Applying a molding material layer again
Repeating the preceding process steps until the produced component corresponds to the data model
Optional: post-hardening the core/the mold in a furnace

1-15. (canceled)

16. A salt core for producing castings comprising a salt and having layered structure,
the layered structure comprising of individually applied and consolidated layers of a molding material.

17. The salt core according to claim 16, wherein the salt core is water-soluble.

18. The salt core according to claim 16, wherein the salt cores have a residual porosity of less than 30% with respect to the total volume of the salt core.

19. The salt core according to claim 16, wherein the finished, additively produced salt core is coated with a water-soluble facing.

20. The salt core according to claim 16, wherein the finished, additively produced salt core has been infiltrated with a water-soluble salt melt.

21. The salt core according to claim 16, wherein the salt core is hollow, it being possible that the interior of the salt core is empty or filled with unconsolidated molding material.

22. The salt core according to claim 16, wherein the salt core comprises at least one component, in particular selected from gears, transmission parts, shaft elements, or drive elements, in form-closed connection, the at least one component being completely or partially surrounded by the salt core.

23. A method for producing a salt core according to claim 16, wherein the salt core is produced by means of an additive manufacturing.

24. The method according to claim 23, wherein a crystalline salt, which is coated with or mixed with a warm- or hot-curing binder, is used as a molding material.

25. The method according to claim 23, wherein the crystalline salt is contained in a unimodal, bimodal, or multimodal grain size distribution.

26. The method according to claim 23, wherein the grain sizes of the crystalline salt are in a range of 0.01 mm to 2 mm.

27. The method according to claim 23, wherein the binder contains a resin selected from the group consisting of a phenolic resin, a phenol-urea-formaldehyde resin, a nitrogen-free phenol-formaldehyde resin, a low-nitrogen phenol-formaldehyde resin, a phenolic resin containing furfuryl alcohol, a furfuryl alcohol-urea-formaldehyde resin, a furan resin, a phenol-modified furan resin, an amino resin, a novolac and a resol.

28. The salt core according to claim 23, wherein a surface shell of the salt core is selectively laser-sintered, the inner molding material portion not being sintered.

29. The method according to claim 23, wherein the salt core produced by means of the additive manufacturing method is post-hardened in a furnace.

30. The method according to claim 23, wherein the method for producing salt cores by means of selective laser sintering comprises the following steps:
producing a data model of a salt core to be produced;
preparing a molding material mixture of salt and binder;
applying a thin molding material layer to a lowerable supporting plate;
selectively hardening the molding material layer in regions corresponding to the data model by means of electromagnetic radiation, particularly by means of laser irradiation, in a computer-controlled manner;
lowering the supporting plate;
applying a molding material layer again; and
repeating the preceding process steps until the produced component corresponds to the data model.

31. The method according to claim 30, further comprising post-hardening the core in a furnace.

32. A method for producing a salt core according to claim 23, wherein the additive manufacturing method is selective laser sintering.
